(19) United States
(12) Patent Application Publication
(10) Pub. No.: US 2017/0107400 A1
(43) Pub. Date: Apr. 20, 2017

(54) ULTRA-THIN POLYIMIDE FILM, AND MANUFACTURE AND ASSEMBLY THEREOF

(71) Applicant: TAIMIDE TECHNOLOGY INCORPORATION, Xinpu Township (TW)

(72) Inventor: Yen-Po Huang, Hsinchu Hsien (TW)

(21) Appl. No.: 15/293,112

(22) Filed: Oct. 13, 2016

(30) Foreign Application Priority Data
Oct. 14, 2015 (TW) 104133656

(51) Int. Cl. C09D 179/08; C08L 79/08; C08G 73/10; C09J 179/08

(52) U.S. Cl. CPC C09D 179/08; C09J 179/08; C08L 79/08; C08G 73/1003; C08G 73/1046; C08L 2203/16

(57) ABSTRACT

A polyimide film structure includes a polyimide layer having a first and a second surface opposite to each other, and a base layer peelably adhered to the first surface of the polyimide layer. The base layer includes a polyimide, and a filler made of a siloxane polymer present at a weight ratio between about 5 wt % and about 40 wt % based on the total weight of the base layer. Moreover, the present application also describes a method of fabricating the polyimide film structure, and its assembly on a substrate.

### CROSS-REFERENCE TO RELATED APPLICATION(S)

This application respectively claims priority to Taiwan Patent Application No. 104133656 filed on Oct. 14, 2015, the disclosure of which is incorporated herein by reference.

### FIELD OF THE DISCLOSURE

The present application generally relates to polyimide films, and more particularly to ultra-thin polyimide films and the manufacture and assembly thereof.

### BACKGROUND OF THE DISCLOSURE

A polyimide coverlay is conventionally used in a print circuit board (PCB) to cover and protect metal circuits formed thereon. As technology advances, the printed circuit board becomes increasingly thinner, lighter and multi-functional. Moreover, the thinner dimension of the printed circuit board requires the use of an ultra-thin polyimide coverlay.

Ultra-thin polyimide films are difficult to fabricate with current processing methods. Some polyimide films currently available on the market may have a thickness less than 10 μm. However, polyimide films with a thickness less than 5 μm are usually not subjected to biaxial orientation, because the stretching process may break the polyimide film. Moreover, the fabrication of the current ultra-thin polyimide films generally does not consider difficulties that may arise during the assembly of the polyimide film on the substrate of the printed circuit board.

Accordingly, there is a need for ultra-thin polyimide films that are convenient to process, and address at least the foregoing issues.

### SUMMARY

The present application describes an ultra-thin polyimide film structure that can be fabricated according to a cost-effective manner, and address at the foregoing problems. In some embodiments, the polyimide film structure includes a polyimide layer having a first and a second surface opposite to each other, and a base layer containing a polyimide that is peelably adhered to the first surface of the polyimide layer. The base layer contains a filler of a siloxane polymer, the filler of siloxane polymer being present at a weight ratio between about 5 wt % and about 40 wt % based on the total weight of the base layer. The peeling strength between the polyimide layer and the base layer is between 0.004 and 0.1 kgf/cm, so that the base layer can be peeled from the polyimide layer.

The present application also describes a method of fabricating a polyimide film structure. In some embodiments, the method includes preparing a base layer containing a polyimide and a filler of siloxane polymer present at a weight ratio between about 5 wt % and about 40 wt % based on the total weight of the base layer, coating a polyamic acid solution on a surface of the base layer, and heating the polyamic acid solution to form a polyimide layer on the base layer, the base layer and the polyimide layer forming a polyimide film structure in which the base layer is peelably adhered to the polyimide layer.

In addition, the present application further provides a method of assembling a polyimide film structure. The method includes providing a polyimide film structure including a polyimide layer having a first and a second surface opposite to each other, and a base layer containing a polyimide that is peelably adhered to the first surface of the polyimide layer, the base layer containing a filler of a siloxane polymer at a weight ratio between about 5 wt % and about 40 wt % based on the total weight of the base layer. Subsequently, the method further includes adhering the polyimide film structure to a substrate, the polyimide film structure being adhered to the substrate at the second surface of the polyimide layer, and peeling the base layer from the first surface of the polyimide layer while the second surface of the polyimide layer remains adhered to the substrate.

### BRIEF DESCRIPTION OF THE DRAWINGS

Some embodiments of the disclosure may be understood by referring, in part, to the present disclosure and the accompanying drawings, wherein:

FIG. 1 is a schematic view illustrating an embodiment of a polyimide film structure, according to a specific example embodiment of the disclosure;

FIG. 2A is a schematic view illustrating a stage in a method of assembling a polyimide film structure with a substrate, according to a specific example embodiment of the disclosure;

FIG. 2B is a schematic view illustrating a stage in a method of assembling a polyimide film structure with a substrate, according to a specific example embodiment of the disclosure;

FIG. 2C is a schematic view illustrating a stage in a method of assembling a polyimide film structure with a substrate, according to a specific example embodiment of the disclosure; and

FIG. 2D is a schematic view illustrating a stage in a method of assembling a polyimide film structure with a substrate, according to a specific example embodiment of the disclosure.

### DETAILED DESCRIPTION OF THE EMBODIMENTS

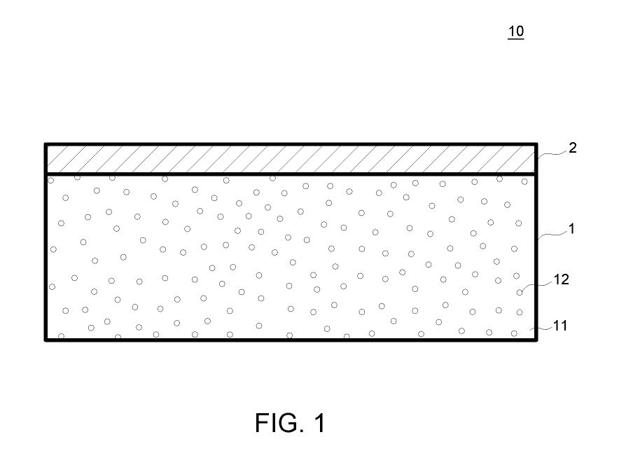

FIG. 1 is a schematic view illustrating an embodiment of an ultra-thin polyimide film structure 10. The polyimide film structure 10 includes a base layer 1, and a polyimide layer 2 that adheres in contact with a surface of the base layer 1. The base layer 1 can be a single layer including a polyimide 11, and a filler 12 made of a siloxane polymer. The filler 12 can be in the form of siloxane polymer particles dispersed in the polyimide 11 of the base layer 1. The base layer 1 can have a surface energy less than 100 dyne/cm and can be easily peeled and removed from the polyimide layer 2.

The polyimide layer 2 can be a single layer made of polyimide. The polyimide layer 2 has a thickness less than about 6 μm. More specifically, the thickness of the polyimide layer 2 is preferably less than about 5 μm, for example between 0.1 μm and 5 μm. In some examples, the thickness of the polyimide layer 2 can be 0.1 μm, 1 μm, 2 μm, 2.5 μm, 3 μm, 4 μm, 4.5 μm, or any intermediate values falling in any ranges defined between any of the aforementioned values.

There is no particular constraint imposed on the thickness of the base layer 1. In some examples, the thickness of the base layer 1 can be between about 5 μm and about 10 μmm. In some variant examples, the thickness of the base layer 1 can be greater than 10 μm.

The filler 12 in the form of siloxane polymer particles can be present in the base layer 1 at a weight ratio between about 5 wt % and about 40 wt % based on the total weight of the base layer 1.

By incorporating the filler of siloxane polymer in the base layer 1, it can be observed that the base layer 1 exhibits reduced surface tension so that the adhesiveness of the base layer 1 to the polyimide layer 2 adhered thereto can be reduced. However, the addition of the siloxane polymer in the base layer 1 still produces a desirable surface tension of the base layer 1, so that the polyimide layer 2 can be directly formed on a surface of the base layer 1. Accordingly, when the polyimide film structure 10 comprised of the base layer 1 and the polyimide layer 2 undergoes subsequent processing (e.g., attachment to a substrate), the base layer 1 can be entirely and easily peeled off from the polyimide layer 2. For example, after the polyimide layer 2 is adhered to a copper foil for preparing a printed circuit board, the base layer 1 can be directly peeled off leaving the polyimide layer 2 adhered to the copper foil. This separation of the base layer 1 can be easily done without breaking the polyimide layer 2 or separating it from the copper foil.

In at least one example of implementation, a peeling strength between the polyimide layer 2 and the base layer 1 can be between about 0.004 and about 0.1 kgf/cm (kilogram-force per cm). Moreover, the base layer 1 may further have a water contact angle greater than 40° (e.g., 50°, 60°, 75°, 90°, 120°, 150°, 180°) or any intermediate values falling in any ranges defined between any of the aforementioned values.

Referring to FIG. 1, a method of manufacturing the polyimide film structure 10 includes preparing the base layer 1 containing the polyimide 11 and the filler 12 made of a siloxane polymer, coating a polyamic acid solution on a surface of the base layer 1, and applying heat to convert the polyamic acid solution on the base layer 1 into the polyimide layer 2, the base layer and the polyimide layer forming a polyimide film structure in which the base layer is peelably adhered to the polyimide layer.

For preparing the base layer 1, selected diamines and dianhydride monomers can be mixed in a solvent to form a first polyamic acid solution, and the filler 12 of siloxane polymer particles is then incorporated and homogeneously mixed in the first polyamic acid solution. The obtained mixture is coated on a glass or stainless steel plate, and then heated at a temperature between about 90° C. and about 350° C. The base layer 1 thereby formed contain a polyimide 11 as a base material, and the filler 12 of siloxane polymer particles dispersed in the polyimide 11 of the base layer 1.

For forming the polyimide layer 2, selected diamines and dianhydride monomers are incorporated and mixed in a solvent to form a second polyamic acid solution. The diamine and dianhydride monomers used for the polyimide layer 2 can be the same, partly the same, or different from the diamine and dianhydride monomers used for forming the base layer 1. Additives, e.g., a pigment, matting agent and the like, can be added in the second polyamic acid solution. The second polyamic acid solution is coated onto a surface of the base layer 1, and then heated at a temperature between about 90° C. and about 350° C. to form the polyimide layer 2 on the base layer 1. The polyimide layer 2 has a thickness preferably less than about 5 μm, e.g., between about 0.1 μm and about 5 μm. A polyimide film structure comprised of the base layer 1 and the polyimide layer 2 adhered to each other can be thereby formed, the base layer 1 being peelable from the polyimide layer 2.

In certain implementations, the polyimide film structure 10 comprised of the base layer 1 and the polyimide layer 2 can further undergo a biaxial stretching process so that both the base layer 1 and the polyimide layer 2 are biaxially oriented, e.g., along the lengthwise and transversal directions of the polyimide film structure. This can enhance the strength of the base layer 1 and the polyimide layer 2.

It is known that biaxial stretching is more difficult for thinner films, and most ultra-thin polyimide films conventionally are not subjected to biaxial stretching. Because it is formed with the ultra-thin polyimide layer 2 directly adhered on the base layer 1, the polyimide film structure 10 described herein can have a suitable thickness so that the biaxial stretching process can be applied without breaking the ultra-thin polyimide film.

The polyimide film structure 10 described herein can be formed by a thermal conversion or a chemical conversion. When a chemical conversion is used, a dehydrant or a catalyst can be added into the polyamic acid solution before the coating step. The solvent can be non-polar and aprotic solvent, e.g., dimethylacetamide (DMAC), N,N′-dimethylformamide (DMF), N-methyl-2-pyrrolidone (NMP), dimethyl sulfoxide (DMSO), tetramethylene sulfone, N,N′-dimethyl-N,N′-propylene urea (DMPU), and the like. The dehydrant can be aliphatic anhydride (e.g., acetic anhydride and propionic anhydride), aromatic anhydride (e.g., benzoic acid anhydride and phthalic anhydride), and the like. The catalyst can be a heterocyclic tertiary amine (e.g., picoline, pyridine, and the like), an aliphatic tertiary amine (e.g., trimethylamine (TEA) and the like), an aromatic tertiary amine (e.g., xylidine and the like), etc. The molar ratio of a polyamic acid: dehydrant: catalyst is 1:2:1. That is, for each mole of polyamic acid solution, about 2 moles of dehydrant and about 1 mole of catalyst are used.

In at least one example of implementation, the polyimide is formed by a condensation reaction of a diamine and dianhydride monomers at a substantially equal molar ratio (i.e., 1:1), e.g., the diamine-to-dianhydride molar ratio can be 0.9:1.1 or 0.98:1.02.

The polyimide of the base layer 1 and the polyimide of the polyimide layer 2 may be formed by reacting diamine monomers with dianhydride monomers. There is no particular constraint imposed on the diamine and dianhydride monomers.

Examples of the diamine monomers can include 4,4′-oxydianiline (4,4′-ODA), p-phenylenediamine (p-PDA), 2,2′-bis(trifluoromethyl)benzidine (TFMB), 1,3-bis(4-aminophenoxy)benzene (TPER), 1,4-bis(4-aminophenoxy)benzene (TPEQ), (2,2′-dimethyl[1,1′-biphenyl]-4,4′-diamine (m-TB-HG), 1,3′-bis(3-aminophenoxy) benzene (APBN), 3,5-diaminobenzotrifluoride (DABTF), 2,2′-bis[4-(4-aminophenoxy) phenyl]propane (BAPP), 6-amino-2-(4-aminophenyl)benzoxazole (6PBOA), or 5-amino-2-(4-aminophenyl)benzoxazole (5PBOA), which can be used individually or in combination.

Examples of the dianhydride monomers can include 3,3′,4,4′-biphenyl-tetracarboxylic dianhydride (BPDA), 2,2-bis[4-(3,4dicarboxyphenoxy) phenyl] propane dianhydride (BPADA), pyromellitic dianhydride (PMDA), 2,2′-bis-(3,4-dicarboxyphenyl) hexafluoropropane dianhydride (6FDA), 4,4-oxydiphthalic anhydride (ODPA), benzophenonetetracarboxylic dianhydride (BTDA), or 3,3′,4,4′-dicyclohexyl-tetracarboxylic acid dianhydride (HBPDA), which can be used individually or in combination.

In some examples, the diamine monomers used for forming the polyimide of the base layer 1 can include 4,4′-ODA, p-PDA, or TFMB, which can be used individually or in combination. Moreover, the dianhydride monomers used for forming the polyimide of the base layer 1 can include PMDA, BPDA, or BPADA, which can be used individually or in combination.

The diamine and dianhydride monomers used for forming the polyimide layer 2 can be similar, partly similar, or different from those used for forming the base layer 1. In some examples, the diamine monomers used for the polyimide layer 2 can include 4,4′-ODA, p-PDA, or TFMB, which can be used individually or in combination. Moreover, the dianhydride monomers used for the polyimide layer 2 can include PMDA, BPDA, or BPADA, which can be used individually or in combination.

The present disclosure also provides a method of assembling the polyimide film structure 10, which includes placing the polyimide film structure on a substrate such that the polyimide layer 2 is adhered to the substrate, and then peeling the base layer 1 off from the polyimide layer 2. The substrate can be a printed circuit board, a laminate structure, a base substrate or the like.

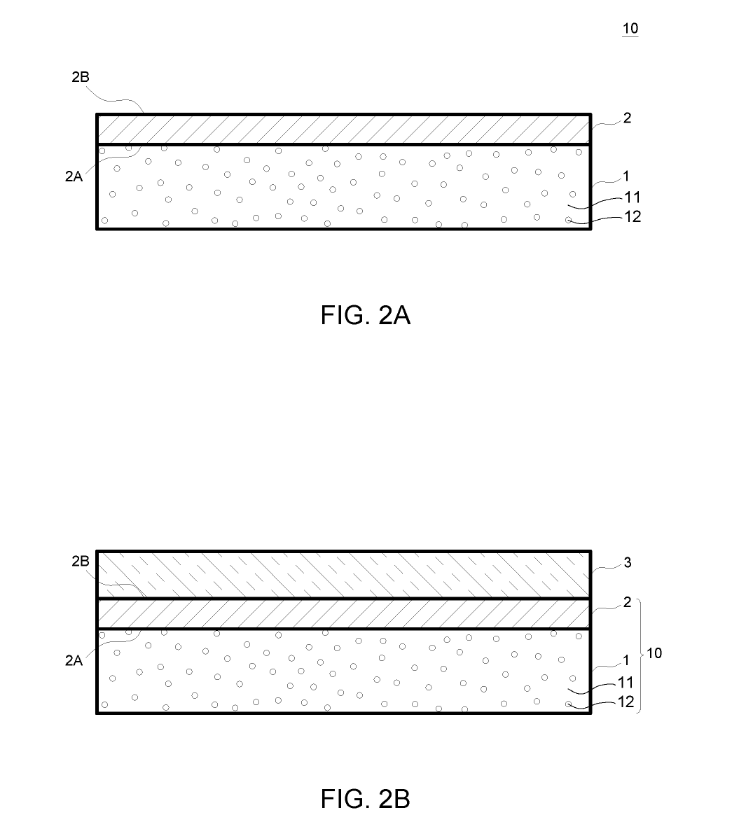

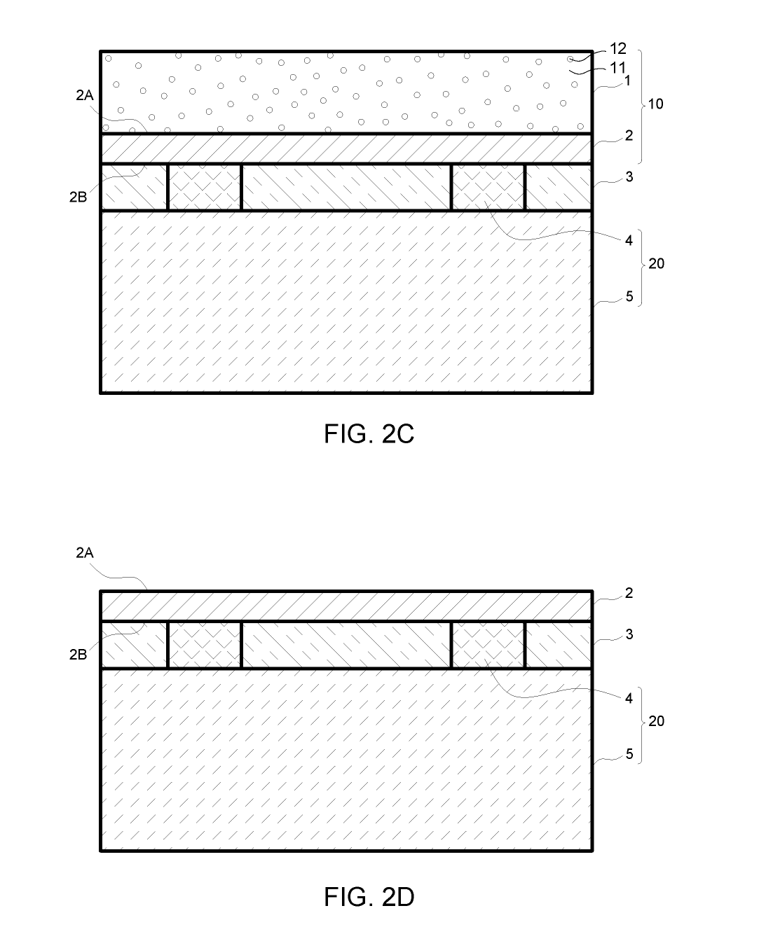

FIGS. 2A-2D are schematic views illustrating an embodiment of a method of assembling the polyimide film structure with a substrate 20. Referring to FIG. 2A, the polyimide film structure 10 including the base layer 1 and the polyimide layer 2 adhered to each other is provided. The polyimide layer 2 has a first surface 2A and a second surface 2B opposite to each other. The first surface 2A of the polyimide layer 2 directly contacts with and adheres to a surface of the base layer 1, while the second surface 2B of the polyimide layer 2 is exposed.

Referring to FIG. 2B, an adhesive substance is applied on the second surface 2B of the polyimide layer 2 to form an adhesive layer 3.

Referring to FIG. 2C, the polyimide film structure 10 is then placed a substrate 20 such that the second surface 2B of the polyimide layer 2 adheres to the substrate 20. The substrate 20 can be a printed circuit board including a metal layer 4 and a base substrate 5.

Referring to FIG. 2D, while the polyimide layer 2 remains adhered to the substrate 20, the base layer 1 is peeled off from the first surface 2A of the polyimide layer 2. The polyimide layer 2 can thereby serve as an ultra-thin coverlay for the substrate 20.

Examples of methods of fabricating the aforementioned polyimide film structure are described hereinafter.

### EXAMPLES

### Example 1

Preparation of a First PAA Solution

About 47.85 g of 4,4′-ODA and about 400 g of DMAC used as solvent are put into a three-necked flask, and agitated at a temperature of about 30° C. until complete dissolution. Then about 49.05 g of PMDA is added and mixed homogeneously. About 5.62 g of silicone powder is then added as a filler of siloxane polymer particles. The quantity of the reacted monomers is 20 wt % of the total weight of the solution. The solution is continuously agitated and reaction occurs at a temperature of 25° C. for 25 hours to form a first polyamic acid (PAA) solution.

Preparation of a second PAA Solution

About 47.85 g of 4,4′-ODA and about 400 g of DMAC used as solvent are put into a three-necked flask, and agitated at a temperature of about 30° C. until complete dissolution. Then about 51.37 g of PMDA is added. The quantity of the reacted monomers is 20 wt % of the total weight of the solution. The solution is continuously agitated and reaction occurs at a temperature of 25° C. for 25 hours to form a second PAA solution.

Preparation of an Ultra-Thin Polyimide Film

The first PAA solution is coated onto a glass plate and heated at 80° C. for 30 minutes to remove most of the solvent. Then, the glass plate with the coated first PAA solution thereon is placed in an oven and heated at 170° C. for 1 hour to form the base layer 1. Subsequently, the second PAA solution is coated onto the base layer 1, and both the base layer 1 and the coated layer of the second PAA solution are heated at a temperature of 80° C. for about 30 minutes. Then, the glass plate with the base layer 1 and the coated second PAA solution thereon is placed in an oven and further heated at 170-370° C. for 4 hour to form the film structure comprised of the base layer 1 and the polyimide layer 2 adhered to each other. The final polyimide film structure has a total thickness equal to about 30 μm, the thickness of the base layer 1 being about 25 μm and the thickness of the ultra-thin polyimide layer 2 being about 5 μm.

### Example 2

A polyimide film structure is prepared like in Example 1, except that about 25 g of silicone powder is added into the first PAA solution. The quantity of the reacted monomers is 20 wt % based on the total weight of the reaction solution.

### Example 3

A polyimide film structure is prepared like in Example 1, except that about 66.67 g of silicone powder is added into the first PAA solution. The quantity of the reacted monomers is 20 wt % based on the total weight of the reaction solution.

Test of the Film Properties

Measure of Water Contact Angle:

A sessile drop technique (DSA10-MK2, Kruss) is applied to measure the water contact angle. A light beam is used to illuminate a water drop, which is imaged by a charge coupling device (CCD) sensor on a monitor. An analysis program is then run to calculate the contact angle of the water drop. The error tolerance of the calculation is ±5°.

Test of Peeling Strength:

A glue layer is applied on the surface of the polyimide layer 2, and a copper foil of about 18 μm in thickness is pressed thereon. Testing is then conducted with a universal testing machine (Hounsfield H10ks) according to IPC-TM650 2.4.9 test method. It is then verified that peeling occurs at the interface between the base layer 1 and the polyimide layer 2.

### Comparative Example 1

A polyimide film structure is prepared like in Example 1, except that about 3.1 g of silicone powder is added into the first PAA solution. The quantity of the reacted monomers is 20 wt % based on the total weight of the reaction solution. Due to the insufficient amount of silicone powder, the polyimide layer cannot be easily separated from the base layer.

### Comparative Example 2

A polyimide film structure is prepared like in Example 1, except that about 81.82 g of silicone powder is added into the first PAA solution. The quantity of the reacted monomers is 20 wt % based on the total weight of the reaction solution. Due to the excessive amount of silicone powder, the multilayered film as described above cannot be formed.

The test results are shown in the Table 1.

TABLE 1

| | | Content of | | |
|---|---|---|---|---|
| | | silicone | Film-forming | Peeling |
| | Monomers | powder | ability | ability |
| Example 1 | ODA + PMDA | 5 wt % | Yes | Yes |
| Example 2 | ODA + PMDA | 20 wt % | Yes | Yes |
| Example 3 | ODA + PMDA | 40 wt % | Yes | Yes |
| Comparative | ODA + PMDA | 3 wt % | Yes | No |
| Example 1 | | | | |
| Comparative | ODA + PMDA | 45 wt % | No | Cannot be |
| Example 2 | | | | detected |

The polyimide film structure described herein can bring several advantages over conventional polyimide films. For example, the smallest thickness of a conventional polyimide film prepared with biaxial stretching is generally about 10 μm (with no base layer). If the polyimide film were to be formed with a thickness less than 10 μm, the conventional processing method requires to laminate the thinner polyimide film on a polyester tape (e.g., PET tape), and then wind the assembly of the polyimide film and the PET tape to form a roll. Unlike the conventional polyimide film assembly, the polyimide film structure described herein can accommodate an ultra-thin polyimide to layer that is less than 6 μm in thickness (or even less than 5 μm), and allow biaxial stretching of the ultra-thin polyimide layer without incurring damages.

Moreover, the substrate described herein can be used for fabricating a flexible circuit board, the base layer providing effective support for carrying out processing steps such as adhesive application on the ultra-thin polyimide layer. After all the requisite processing steps on the polyimide layer are completed, the base layer can be easily removed to achieve a substantially thin product. Accordingly, the film structure as described herein can facilitate the fabrication process at an economical cost.

Realizations of the polyimide film structure and its method of fabrication and assembly have been described in the context of particular embodiments. These embodiments are meant to be illustrative and not limiting. Many variations, modifications, additions, and improvements are possible. These and other variations, modifications, additions, and improvements may fall within the scope of the disclosure as defined in the claims that follow.

What is claimed is:

1. A polyimide film structure comprising:
a polyimide layer having a first and a second surface opposite to each other; and
a base layer containing a polyimide that is peelably adhered to the first surface of the polyimide layer, the base layer comprising a filler made of a siloxane polymer dispersed therein, the filler being present at a weight ratio between about 5 wt % and about 40 wt % based on the total weight of the base layer.

2. The polyimide film structure according to claim 1, wherein the polyimide layer has a thickness less than 6 micrometers.

3. The polyimide film structure according to claim 1, wherein the filler is in the form of particles.

4. The polyimide film structure according to claim 1, wherein the peeling strength between the polyimide layer and the base layer is between 0.004 and 0.1 kgf/cm.

5. The polyimide film structure according to claim 1, wherein the polyimide of the base layer is formed by condensation reaction of diamine monomers with dianhydride monomers, the diamine monomers being selected from the group consisting of 4,4′-oxydianiline (4,4′-ODA), phenylenediamine (p-PDA) and 2,2′-Bis(trifluoromethyl)benzidine (TFMB), and the dianhydride monomers being selected from the group consisting of pyromellitic dianhydride (PMDA), 3,3′,4,4′-biphenyl-tetracarboxylic dianhydride (BPDA), and 2,2-bis[4-(3,4dicarboxyphenoxy) phenyl] propane dianhydride (BPADA).

6. The polyimide film structure according to claim 1, wherein the polyimide layer is formed by condensation reaction of diamine monomers with dianhydride monomers, the diamine monomers being selected from the group consisting of 4,4′-oxydianiline (4,4′-ODA), phenylenediamine (p-PDA) and 2,2′-Bis(trifluoromethyl)benzidine (TFMB), and the dianhydride monomers being selected from the group consisting of pyromellitic dianhydride (PMDA), 3,3′,4,4′-biphenyl-tetracarboxylic dianhydride (BPDA), and 2,2-bis[4-(3,4dicarboxyphenoxy) phenyl] propane dianhydride (BPADA).

7. A method of fabricating a polyimide film structure, comprising:
preparing a base layer containing a polyimide, and a filler made of a siloxane polymer that is dispersed in the polyimide, the filler being present at a weight ratio between about 5 wt % and about 40 wt % based on the total weight of the base layer;
coating a polyamic acid solution on a surface of the base layer; and
heating the polyamic acid solution to form a polyimide layer on the base layer, the base layer and the polyimide layer forming a polyimide film structure in which the base layer is peelably adhered to the polyimide layer.

8. The method according to claim 7, further comprising:
while the base layer and the polyimide layer are adhered to each other, biaxially stretching the polyimide film structure.

9. The method according to claim 7, wherein the polyimide layer has a thickness less than 6 micrometers.

10. The method according to claim 7, wherein the filler is in the form of particles.

11. The method according to claim 7, wherein the polyimide of the base layer is formed by condensation reaction of diamine monomers with dianhydride monomers, the diamine monomers being selected from the group consisting of 4,4′-oxydianiline (4,4′-ODA), phenylenediamine (p-PDA) and 2,2′-Bis(trifluoromethyl)benzidine (TFMB), and the dianhydride monomers being selected from the group consisting of pyromellitic dianhydride (PMDA), 3,3′,4,4′-biphenyl-tetracarboxylic dianhydride (BPDA), and 2,2-bis[4-(3,4dicarboxyphenoxy) phenyl] propane dianhydride (BPADA).

12. The method according to claim 7, wherein the polyimide layer is formed by condensation reaction of diamine monomers with dianhydride monomers, the diamine monomers being selected from the group consisting of 4,4′-oxydianiline (4,4′-ODA), phenylenediamine (p-PDA) and 2,2′-Bis(trifluoromethyl)benzidine (TFMB), and the dianhydride monomers being selected from the group consisting of pyromellitic dianhydride (PMDA), 3,3′,4,4′-biphenyl-tetracarboxylic dianhydride (BPDA), and 2,2-bis[4-(3,4dicarboxyphenoxy) phenyl] propane dianhydride (BPADA).

13. A method of assembling a polyimide film on a substrate, comprising:
providing a polyimide film structure including a polyimide layer having a first and a second surface opposite to each other, and a base layer containing a polyimide that is peelably adhered to the first surface of the polyimide layer, wherein the base layer further comprises a filler made of a siloxane polymer, the filler being present at a weight ratio between about 5 wt % and about 40 wt % based on the total weight of the base layer;
adhering the polyimide film structure to a substrate, the polyimide film structure being adhered to the substrate at the second surface of the polyimide layer; and
while the second surface of the polyimide layer remains adhered to the substrate, peeling the base layer from the first surface of the polyimide layer.

14. The method according to claim 13, wherein the polyimide layer has a thickness less than 6 micrometers.

15. The method according to claim 13, wherein the filler is in the form of particles.

16. The method according to claim 13, wherein the polyimide of the base layer is formed by condensation reaction of diamine monomers with dianhydride monomers, the diamine monomers being selected from the group consisting of 4,4′-oxydianiline (4,4′-ODA), phenylenediamine (p-PDA) and 2,2′-Bis(trifluoromethyl)benzidine (TFMB), and the dianhydride monomers being selected from the group consisting of pyromellitic dianhydride (PMDA), 3,3′,4,4′-biphenyl-tetracarboxylic dianhydride (BPDA), and 2,2-bis[4-(3,4dicarboxyphenoxy) phenyl] propane dianhydride (BPADA).

17. The method according to claim 13, wherein the polyimide layer is formed by condensation reaction of diamine monomers with dianhydride monomers, the diamine monomers being selected from the group consisting of 4,4′-oxydianiline (4,4′-ODA), phenylenediamine (p-PDA) and 2,2′-Bis(trifluoromethyl)benzidine (TFMB), and the dianhydride monomers being selected from the group consisting of pyromellitic dianhydride (PMDA), 3,3′,4,4′-biphenyl-tetracarboxylic dianhydride (BPDA), and 2,2-bis[4-(3,4dicarboxyphenoxy) phenyl] propane dianhydride (BPADA).

18. The method according to claim 13, wherein the substrate is a printed circuit board.
